(19) United States
(12) Patent Application Publication
(10) Pub. No.: US 2008/0024790 A1
(43) Pub. Date: Jan. 31, 2008

(54) Image Rotation Devices and Their Applications

(75) Inventors: Tongxin Lu, San Jose, CA (US); Xiaohan Wang, Alameda, CA (US)

Correspondence Address: EMIL CHANG;LAW OFFICES OF EMIL CHANG, 874 JASMINE DRIVE, SUNNYDALE, CA, 94086, US

(73) Assignee: Raintree Scientific Instruments (Shanghai) Corporation, Santa Clara, CA (US)

(21) Appl. No.: 11/831,880

(22) Filed: Jul. 31, 2007

Related U.S. Application Data
(60) Provisional application No. 60/834,048, filed on Jul. 31, 2006.

(51) Int. Cl. G01B 9/02

(52) U.S. Cl. 356/521

(57) ABSTRACT

An optical inspection device of a device-under-test is disclosed, said device comprising a light source, an image rotator, a parabolic reflector, and one or more detectors, wherein said light source provides a light beam traveling through said image rotator and reflecting off said parabolic reflector to a device-under-test and thereby creating diffracted light beams off said device-under-test, and said diffracted light beams reflecting off said parabolic reflector and travels through said image rotator and are received by the detectors.

### PRIORITY CLAIM

This application claims priority from a provisional patent application entitled “Image Rotation devices and Their Applications” filed on Jul. 31, 2006, having an application No. 60/834,048. This application is incorporated herein by reference in its entirety.

### FIELD OF INVENTION

The present invention relates to the inspection and measurement systems, and in particular, to optical inspection and measurement of devices-under-test (“DUT”) such as semiconductor devices and/or wafers.

### BACKGROUND

Optical silicon wafer inspections collect and analyze optical signals generated from areas of interest on a wafer in order to determine the quality of the wafer from the fabrication process. Information in these areas can be collected in one method, the x-y 2-dimensional scanning method, by doing 2-dimensional scanning in the x-y plane, or in another method, the rotation method, by rotating the wafer around its center axis and linear moving the wafer in 1-dimension. The x-y 2-dimensional scanning method can be used for both patterned and unpatterned wafers. The rotation method is potentially fast and requires less space. However, because the pattern of interest rotates as well while the wafer is rotating, it would be difficult to use the rotation method for patterned wafers and thus the application of the rotation method is mostly limited for unpatterned wafers.

It would be desirable to have inspection systems utilizing the rotation method that rotate a wafer around its center axis and linear moving in 1-dimension in the inspection of a patterned wafer, where inspection includes optical patterned silicon wafer inspection, defect review, critical dimension measurement, and other relevant applications.

### SUMMARY OF INVENTION

An object of the present invention is to provide methods and devices that utilize a rotation method in the inspection of DUT.

Another object of the present invention is to provide methods and devices that utilize a rotation method in the inspection of patterned DUT.

Another object of the present invention is to provide methods and devices that utilize a rotation method in the inspection of a DUT where the DUT is moved by rotating along its center axis.

Briefly, the present invention discloses an optical inspection device, comprising a light source, an image rotator, a parabolic reflector; and one or more detectors, wherein said light source provides a light beam traveling through said image rotator and reflecting off said parabolic reflector to a device-under-test and thereby creating diffracted light beams off said device-under-test, and said diffracted light beams reflecting off said parabolic reflector and travels through said image rotator and are received by the detectors.

An advantage of the present invention is that it provides methods and devices that utilize a rotation method in the inspection of DUT.

Another advantage of the present invention is that it provides methods and devices that utilize a rotation method in the inspection of patterned DUT.

Another advantage of the present invention is that it provides methods and devices that utilize a rotation method in the inspection of a DUT where the DUT is moved by rotating along its center axis.

### DRAWINGS

The following are further descriptions of the invention with reference to figures and examples of their applications.

FIG. 1 illustrates a side view of a presently preferred embodiment of the present invention.

FIG. 2a, 2b, 2c and 2d are top-views of the light source, and the detectors at the top of the image rotator and at the top of the parabolic reflector.

FIG. 3a shows one option of an all-reflective image rotator.

FIG. 3b is a side-view of FIG. 3a, where the image rotator rotates around the axis.

FIG. 4 shows an alternate embodiment of the present invention with a normal incidence angle.

FIG. 5 shows another alternate embodiment of the present invention with an image detection array and one or more lenses.

FIG. 6 shows an alternate embodiment of the embodiment 2 (shown in FIG. 4) where the optical image rotator is replaced with an array of detectors.

### DETAILED DESCRIPTION OF THE PREFERRED EMBODIMENTS

The presently preferred embodiment of the present invention may comprise of the following elements:
1. One or more mirrors or lenses or a parabolic reflector, such as the parabolic reflector previously disclosed in non-provisional patent application Ser. No. 11/735,979, where the parabolic reflector may be stationary or may rotate with an image rotator;
2. An image rotator, such as an image rotator described below or combinations thereof: (1) a Dove prisms image rotator; (2) a reflective image rotator such as one disclosed in non-provisional patent application Ser. No. 11/747,173; or (3) an image sensor array with electronic or digital signal processing to perform image rotations;
3. A light source, providing for an oblique angle incidence with a relative stationary azimuth angle to pattern a rotating wafer. A light source using a normal (or near normal) angle of incidence can be used as well. The light source itself can be a broad band light source, monochromic light source, or others. Options to use variable spectral filters, variable polarizers, variable intensity control, variable position control, and variable spot dimension and shape control can be added. Light sources for auto-focusing can be provided as well;
4. One or more detectors, a detector can be provided in a single area, or spot optical detectors with stationary positions can be provided after an image rotator. A detector array after an image rotator can be used as well, or used with or without an image rotator. A detector can be used with optional variable spectral filters, variable polarization analyzers, variable position control, variable intensity neutral filters, and variable aperture control, etc. A detector can be used for auto-focusing as well; and
5. A computer for (a) synchronization of motions; (b) storage of data; (c) signal processing and data analysis; and/or (d) other purposes.

Mechanical motion(s) of the presently preferred embodiment may include the following: a silicon wafer may rotate in an x-y plane around a wafer center; an optical image rotator (if any) may be rotated; the relative position of an optical setup and the silicon wafer may be moved in a pre-defined direction; and other motions.

Applications of the present invention may include the following inspection items: (a) defect inspection with DUT rotation; (b) defect review with DUT rotation; (c) optical critical dimension measurement with DUT rotation; (d) other optical metrology with DUT rotation; and (e) other relevant applications.

### Embodiment 1

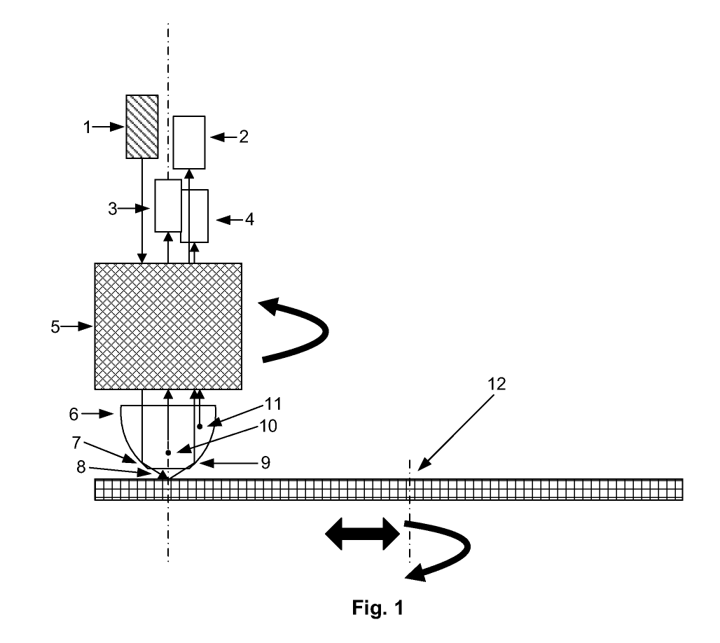

FIG. 1 illustrates a side view of a presently preferred embodiment of the present invention. The collimated beam from light source 1 passes through an image rotator 5 and reflects from the mirror surface spot 7 of the parabolic reflector 6, then focuses on the focal point 8 of the wafer 12 (or any device-under-test). The mirror surface spot 9 reflects the specular beam into the image rotator 5 and reaches the specular beam detector 2. The mirror surface spot 10 reflects its diffracted light from the focal spot 8 into the image rotator 5 and reaches its corresponding detector 3. The mirror surface spot 11 reflects its diffracted light from the focal spot 8 into the image rotator 5 and reaches its corresponding detector 4. The wafer 12 rotates clockwise in an x-y plane around its center and moves along the x-axis. The image rotator rotates counter-clockwise to completely de-rotate the pattern on the focal spot 8 of wafer 12. In addition, the specular beam detector 2 can provide auto-focusing function.

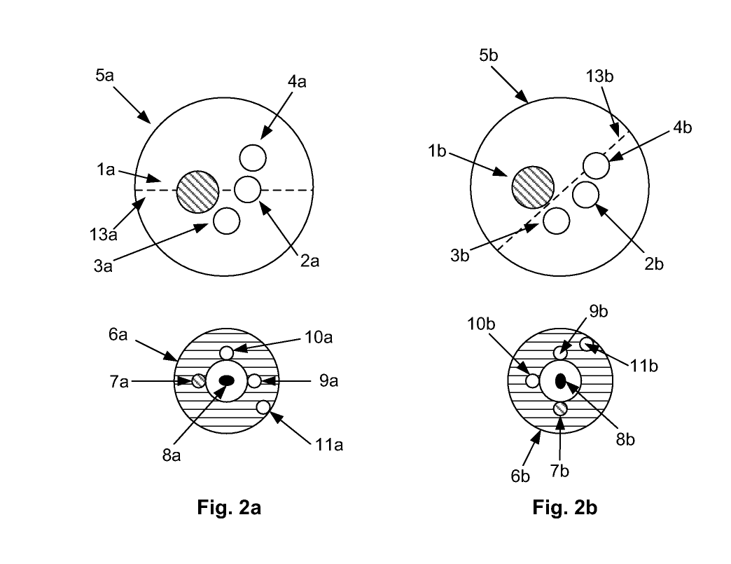

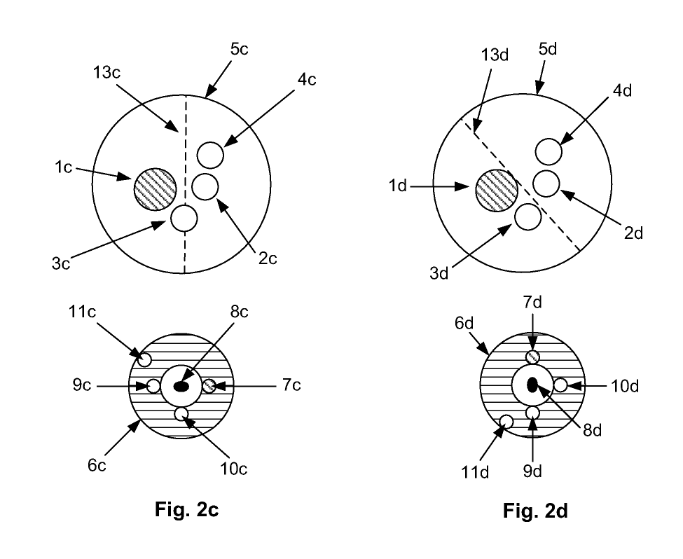

FIG. 2a, 2b, 2c and 2d are top-views of the light source and the detectors at the top of the image rotator and at the top of the parabolic reflector (see FIG. 1) corresponding to four sample wafer rotation angles.

In FIG. 2a, top figure, the dashed-line 13a represents the rotation angle of the image rotator 5a where a mirror image in the lower part of the figure is folded symmetrically along the axis 13a. FIG. 2a, bottom figure, shows a top-view of the parabolic reflector 6a, which can be stationary. On the top of the image rotator, there are four components: there is a light source 1a, and light detectors 2a, 3a and 4a. On the surface of the mirror, there are four-interested light reflecting spots. They are incident light 7a detected by light spots 9a, 10a and 11a. Because of the image rotator, on the surface of the parabolic reflector 6a, light spots 7a, 9a, 10a and 11a are in corresponding mirror image positions of 1a, 2a, 3a, and 4a along line 13a. A light travels through 1a through the image rotator 5a to the mirror spot 7a and the focal spot 8a on the wafer surface. The specular beam is reflected through 9a through the image rotator to reach the corresponding detector 2a. The diffracted spot 10a is mirrored back to the detector 3a, and the other diffracted spot 11a is mirrored back to its detector 4a.

In FIG. 2b, the image rotator rotates to a 45-degree position as shown by line 13b, corresponding to a wafer 90-degree rotation. Because of the image rotator, on the surface of the parabolic reflector 6b, the spots 7b, 9b, 10b and 11b are in corresponding mirror image positions of 1b, 2b, 3b, and 4b along line 13b.

In FIG. 2c, the image rotator rotates to a 90-degree position as shown by line 13c, corresponding to a wafer 180-degree rotation. Because of the image rotator, on the surface of the parabolic reflector 6c, the spots 7c, 9c, 10c and 11c are in corresponding mirror image positions of 1c, 2c, 3c, and 4c along line 13c.

In FIG. 2d, the image rotator rotates to a 135-degree position as shown by line 13d, corresponding to a wafer 270-degree rotation. Because of the image rotator, on the surface of the parabolic reflector 6d, the spots 7d, 9d, 10d and 11d are in corresponding mirror image positions of 1d, 2d, 3d, and 4d along line 13d.

As shown in FIGS. 2a, 2b, 2c, and 2d, as the wafer rotates 360-degree, the image rotator rotates 180-degree to de-rotate (or adjust) images of the wafer, where the light source, the detectors, and the parabolic reflector are kept stationary. The light source shown in the figures is chosen as having an oblique angle incidence. Other angles of incidence can be chosen as well such as a normal (or near normal) angle incidence configured as positioning the light source along the center of the rotation axis of the image rotator.

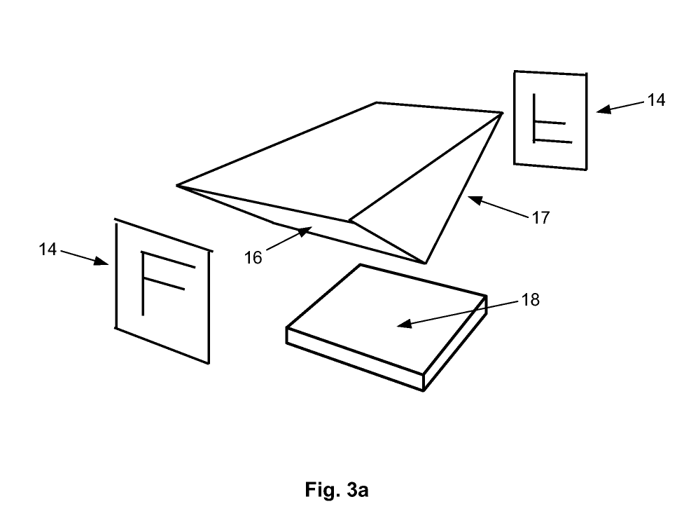

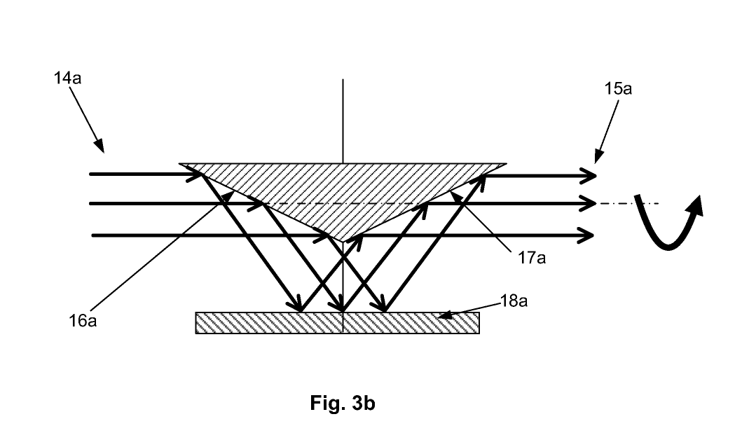

FIG. 3a shows one option of an all-reflective image rotator, where image 14 is an original image and image 15 is its rotated mirror image, and 16, 17 and 18 are mirrors. FIG. 3b is a side-view of FIG. 3a, where the image rotator rotates around the axis.

### Embodiment 2

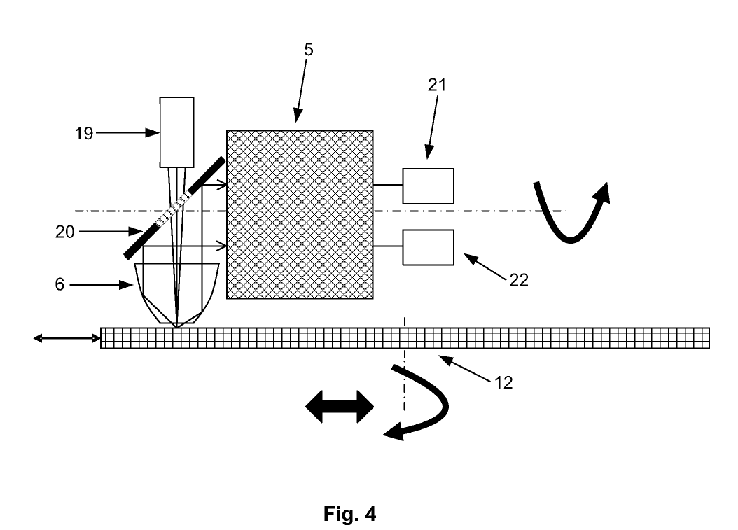

FIG. 4 shows an alternate embodiment of the present invention where the light source provides a light beam with a normal (or near normal) incidence angle. In FIG. 4, a light source 19 directly focuses on the wafer surfaces, and a circular mirror (with an opening in the center of the mirror) or a half mirror 20 reflects the diffracted lights through the image rotator 5, and the diffracted lights are detected by detectors such as detector 21 and detector 22. Note that the detector(s) detects the DUT at the same relative azimuth angle to the patterns on the DUT even though the DUT is being rotated.

Furthermore, in yet another alternate embodiment, the locations of the light source and the detectors can be interchanged such that the light source is provided at the place of the detectors and the detectors are provided at the place of the light source.

### Embodiment 3

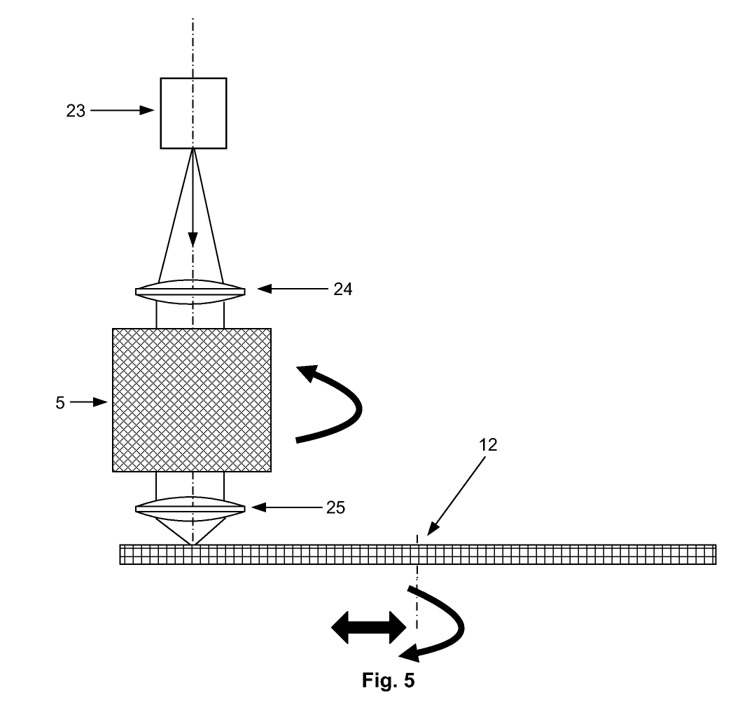

FIG. 5 shows another alternate embodiment of the present invention with a light source 23, an image detection array 23 (the light source and the detector can be in the same housing), lenses 24 and 25, or a lens 25 alone (light sources are not shown).

### Embodiment 4

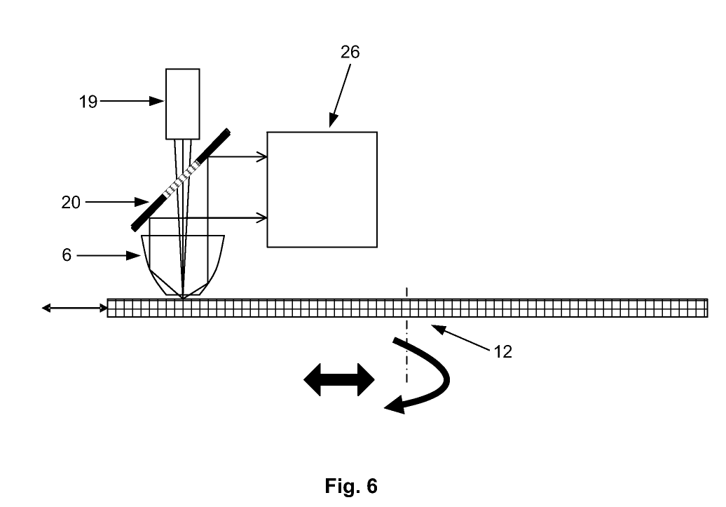

FIG. 6 shows an alternate embodiment of the embodiment 2 (shown in FIG. 4) where the optical image rotator is replaced with an array of detectors. The de-rotation of wafer images is performed with digital processing techniques or software techniques.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

We claim:

1. An optical inspection device, comprising:
a light source;
an image rotator;
a parabolic reflector; and
one or more detectors;
wherein said light source provides a light beam traveling through said image rotator and reflecting off said parabolic reflector to a device-under-test and thereby creating diffracted light beams off said device-under-test, and said diffracted light beams reflecting off said parabolic reflector and travels through said image rotator and are received by the detectors.

2. The optical inspection device of claim 1 wherein said image rotator is an image sensor array where image rotations are performed via digital signal processing.

3. The optical inspection device of claim 1 wherein the device-under-test rotates in a single direction synchronized with the image rotator.

4. The optical inspection device of claim 1 wherein the device-under-test rotates along its center axis.

5. The optical inspection device of claim 3 wherein the device-under-test rotates along its center axis.

6. The optical inspection device of claim 1 wherein the light source provides an oblique incidence light beam.

7. A method for inspecting a device-under-test, comprising the steps of:
providing a light beam;
first rotating the light beam;
directing the rotated light beam to a device-under-test and creating diffracted light beams off said device-under-test;
second rotating the diffracted light beams; and
detecting the diffracted light beams.

8. The method of claim 7 wherein the second rotating the diffracted light beams is a de-rotation of the diffracted light beams.

9. The method of claim 7 wherein the light beam has an oblique incidence angle.

10. The method of claim 7 wherein the device-under-test is rotated in synchronization with the first rotating step.

11. The method of claim 7 wherein the device-under-test is rotated along its center axis.

12. An optical inspection device, comprising:
a light source;
a mirror;
a parabolic reflector;
an image rotator; and
one or more detectors;
wherein said light source provides a light beam traveling through said mirror to a device-under-test and thereby creating diffracted light beams off said device-under-test, and said diffracted light beams reflecting off said parabolic reflector and reflects off said mirror and travels through said image rotator and are received by the detectors.

13. The optical inspection device of claim 12 wherein said image rotator is an image sensor array where image rotations are performed via digital signal processing.

14. The optical inspection device of claim 12 wherein the device-under-test rotates in a single direction synchronized with the image rotator.

15. The optical inspection device of claim 12 wherein the device-under-test rotates along its center axis.

16. The optical inspection device of claim 15 wherein the device-under-test rotates along its center axis.

17. The optical inspection device of claim 12 wherein the light source provides a normal incidence light beam.

18. The optical inspection device of claim 12 wherein the mirror is a half-mirror.

19. The optical inspection device of claim 12 wherein the mirror is a circular-mirror.

20. A method for inspecting a device-under-test, comprising the steps of:
providing a light beam to a device-under-test and creating diffracted light beams off said device-under-test;
directing and rotating the diffracted light beams; and
detecting the diffracted light beams.

21. The method of claim 20 wherein the light beam has a normal incidence angle.

22. The method of claim 20 wherein the device-under-test is rotated in synchronization with the rotating step.

23. The method of claim 20 wherein the device-under-test is rotated along its center axis.

24. The method of claim 20 wherein the directing step utilizes a half-mirror.

25. The method of claim 20 wherein the directing step utilizes a circular-mirror.
